(19) United States
(12) Patent Application Publication
(10) Pub. No.: US 2017/0009497 A1
(43) Pub. Date: Jan. 12, 2017

(54) LOCKING DEVICE

(71) Applicant: PIOLAX, INC., Yokohama-shi, Kanagawa (JP)

(72) Inventor: Hisashi NAKASONE, Yokohama-shi (JP)

(21) Appl. No.: 15/119,680

(22) PCT Filed: Feb. 17, 2015
(86) PCT No.: PCT/JP2015/054278

§ 371 Date: Aug. 17, 2016

(30) Foreign Application Priority Data
Feb. 21, 2014 (JP) 2014-031732

(51) Int. Cl. E05B 83/30; E05C 9/04

(52) U.S. Cl. CPC E05B 83/30; E05C 9/04

(57) ABSTRACT

A locking device configured to lock an opening and closing member with respect to an engagement-receiving member, wherein: an actuating member actuates in accordance with the manipulation of an operating member; a first locking member has a lock linking unit that connects to the actuating member, a first extending portion that extends from the lock linking unit and advances into and retreats from an engaging hole portion formed on the engagement-receiving member in accordance with the actuation of the actuating member, and a second extending portion that extends from the lock linking unit or the first extending portion; and a regulating unit regulates the movement of the second extending portion in the direction that removes the linking of the actuating member and the lock linking unit.

### TECHNICAL FIELD

The present invention relates to a locking device to be mounted on an opening and closing member.

### BACKGROUND ART

A locking device for holding an opening and closing member in a closed state is mounted on the opening and closing member to open and close an opening of a glove compartment of a vehicle. A user unlocks to open the glove compartment by manipulating a manipulation member of the locking device.

For example, Patent Literature 1 discloses a side locking device mounted on a door panel to open and close an opening of a storage box. The side locking device includes a base member fixed to a door panel, a manipulation member rotatably supported by the base member, a link member to oscillate in accordance with the manipulation of the manipulation member, and a locking rod to be connected to the link member to move in accordance with the swing of the link member.

The distal end portion of the locking rod of Patent Literature 1 protrudes outward from a hole provided to the door panel while the back end portion is connected to the link member. When the door panel is closed, the distal end portion of the locking rod abuts on the inner surface of the storage box to move inward. Reaching at the position of an engaging hole provided to the storage box, the distal end portion moves outward to be engaged with the engaging hole.

### CITATION LIST

### Patent Literature

### Patent Literature 1

JP-2012-246727-A

### SUMMARY OF THE INVENTION

### Problem that the Invention is to Solve

In the technique described in Patent Literature 1, when the distal end portion of the locking rod abuts on the inner surface of the storage box in closing the door panel, the back end portion of the locking rod receives a floating-up force from the base member by a reaction force from the storage box. Thus, the locking rod might be disconnected from the link member.

The present invention is made in view of the above problem, and an object of the present invention is to provide a locking device in which a locking member is allowed to be hardly disconnected from a driving member.

### Means for Solving the Problem

To solve the above-described problem, an aspect of the present invention provides,
a locking device that is mounted on an opening and closing member provided in an openable and closable manner to an opening portion of a mount-base member so as to hold the opening and closing member in a locked stated, the locking device including:
a driving member that drives in accordance with manipulation of a manipulation member;
a locking member that includes:
   a connecting portion connected to the driving member;
   a first extending portion that extends from the connecting portion and advances to and retreats from an engaging hole portion formed in the mount-base member in accordance with driving of the driving member; and
   a second extending portion that extends from one of the connecting portion and the first extending portion; and
a limiting portion that limits movement of the second extending portion in a direction of disconnecting the connecting portion from the driving member.

### Advantageous Effects of Invention

According to the present invention, the locking member is allowed to be hardly disconnected from the driving member in the locking device.

### BRIEF DESCRIPTION OF THE DRAWINGS

FIGS. 1A and 1B are views for illustrating an opening and closing member on which a locking device according to an embodiment of the present invention is mounted.

FIG. 2 is a perspective view of the locking device as viewed from a back side thereof.

FIG. 3A is a side view of the locking device, and FIG. 3B is a back side view of the locking device.

FIG. 4 is a view for illustrating a locking device according to a comparative technique.

FIGS. 5A and 5B are views for illustrating the movement of the locking device according to the comparative technique.

FIG. 6 is a view for illustrating the movement of the locking device according to the present embodiment.

FIGS. 7A and 7B are views for illustrating a manipulation member.

FIG. 8A is a perspective view of a base member as viewed from a back side thereof, and FIG. 8B is a side view of the base member.

FIG. 9A is a front side view of the base member, and FIG. 9B is a back side view of the base member.

FIGS. 10A to 10C are views for illustrating a rotor member included in a driving member.

FIGS. 11A to 11C are views for illustrating a first locking member.

FIG. 12 is a cross-sectional view of the locking device taken along the line B-B of FIG. 3B.

FIG. 13 is a view for illustrating a locking device according to the first modification.

FIGS. 14A to 14C are views for illustrating a locking device according to the second modification.

FIG. 15A is a perspective view of a first locking member according to the third modification as viewed from a front side thereof, and FIG. 15B is a perspective view of a first locking member according to the fourth modification as viewed from a front side thereof.

### MODE FOR CARRYING OUT THE INVENTION

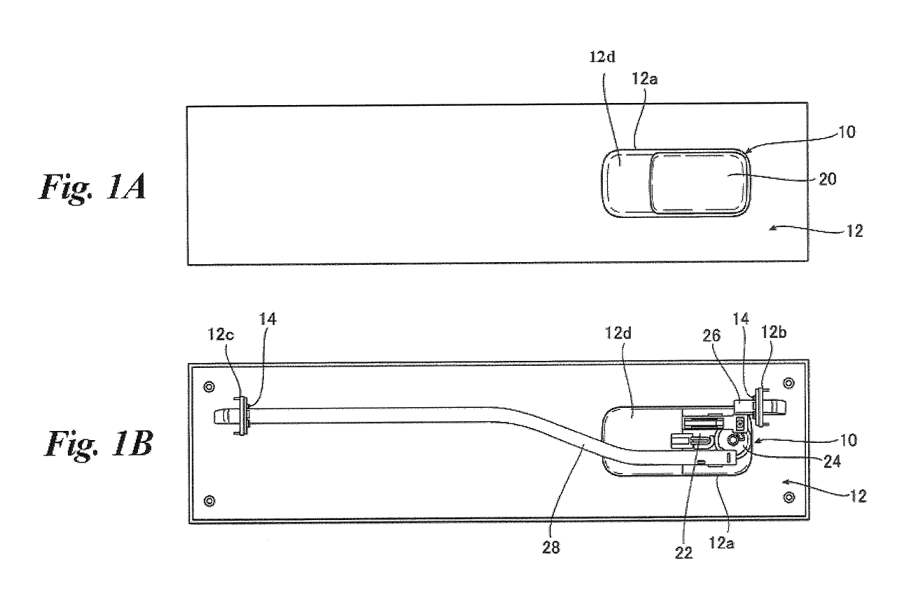

FIGS. 1A and 1B are views for illustrating an opening and closing member 12 on which a locking device 10 according to an embodiment of the present invention is mounted. FIG. 1A is a front side view of the locking device 10 and the opening and closing member 12 when the opening and closing member 12 is viewed from the front side. FIG. 1B is a back side view of the locking device 10 and the opening and closing member 12 when the opening and closing member 12 is viewed from the back side. While the opening and closing member 12 is actually made of two plate members bonded together to house the locking device 10 inside thereof, the plate member on the back side of the opening and closing member 12 that covers the locking device 10 is not illustrated in FIG. 1B.

The opening and closing member 12 defines, for example, a lid member for a vehicle glove compartment. The opening and closing member 12 is illustrated in a flat shape in FIGS. 1A and 1B for the sake of illustration. However, the opening and closing member 12 actually takes the shape of an opening portion of a glove compartment, for example, may be curved. A glove compartment defines a mount-base member including a concave area that defines housing space provided to a dashboard. The opening and closing member 12 is rotatably mounted on the glove compartment to open and close an opening portion of the concave area.

The opening and closing member 12 includes a mounting port 12a for mounting the locking device 10 on the opening and closing member 12. The locking device 10 mounted on the opening and closing member 12 holds the opening and closing member 12 in a locked state with respect to the opening portion of the glove compartment. The locking device 10 according to the present embodiment may be a side-type locking device in which the manipulation member 20 is manipulated in the width direction of the opening and closing member 12.

The locking device 10 includes a manipulation member 20, a base member 22, a driving member 24, a first locking member 26, and a second locking member 28. As illustrated in FIG. 1A, the manipulation member 20 is exposed to the front side from the mounting port 12a. A user inserts his/her fingers from a depressed portion 12d to the back side of the manipulation member 20, and pulls the manipulation member 20 to release the locked state.

The driving member 24 is rotatably supported by the base member 22, and connected to the first locking member 26 and the second locking member 28 (referred to simply as the “locking members” when they are not distinguished from each other). The manipulating force by the user is transmitted from the manipulation member 20 to the driving member 24 illustrated in FIG. 1B, and then from the driving member 24 to the locking members. The locking members having a rod shape are interlocked with the rotational movement of the driving member 24 to move in the longitudinal direction.

The first locking member 26 is inserted into a first insertion hole portion 12b and a retaining portion 14. The second locking member 28 is inserted into a second insertion hole portion 12c and a retaining portion 14. Although not illustrated in FIG. 1B, the back side of the opening and closing member 12 covers up the back side of the locking device 10. In this state, a distal end portion of the first locking member 26 is outwardly exposed through the first insertion hole portion 12b and the retaining portion 14, and a distal end portion of the second locking member 28 is outwardly exposed through the second insertion hole portion 12c and the retaining portion 14.

The first insertion hole portion 12b and the second insertion hole portion 12c include through-holes into which the locking members are insertable. The retaining portions 14 are fixed to the inner circumferences of the first insertion hole portion 12b and the second insertion hole portion 12c, and define elastic members including through-holes. The retaining portions 14 are brought into elastic contact with the locking members to guide the movement of the locking members while preventing the locking members from rattling.

User's manipulation of the manipulation member 20 rotationally moves the driving member 24, and in accordance with the rotational movement of the driving member 24, the locking members separately get in and get out of engaging hole portions (not illustrated) provided to the glove compartment that defines a mount-base member. When the locking members get in the engaging hole portions of the glove compartment, the opening and closing member 12 is brought into a locked state. When the locking members get out of the engaging hole portions, the opening and closing member 12 is brought into an unlocked state.

The locking device 10 according to the present embodiment is disposed on the opening and closing member 12 at a position shifted to one side from the center in the width direction. With this configuration, the locking device 10 of the glove compartment that is disposed, for example, in front of a front passenger seat can be disposed so as to be easily reached from a driver seat. The first insertion hole portion 12b and the second insertion hole portion 12c are disposed at regular intervals from the center of the opening and closing member 12. Therefore, the distance from the driving member 24 to the first insertion hole portion 12b is different from the distance from the driving member 24 to the second insertion hole portion 12c. Thus, the first locking member 26 is different in length in the longitudinal direction from the second locking member 28, so that the first locking member 26 is shorter in the longitudinal direction than the second locking member 28.

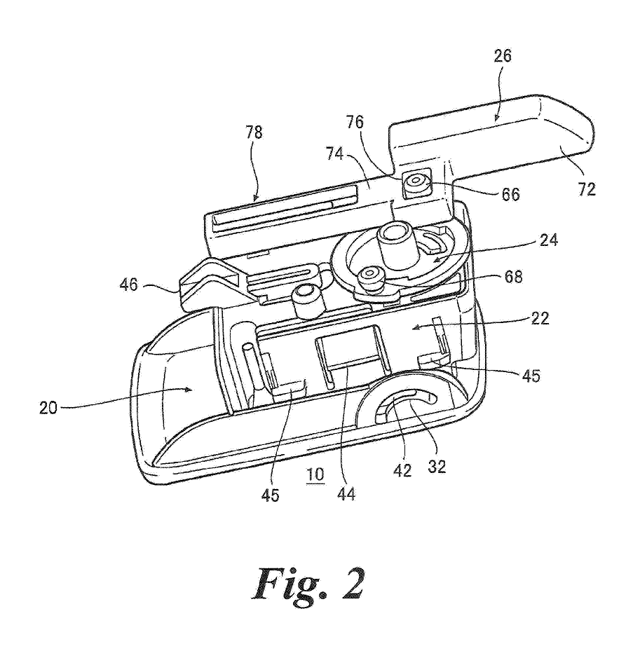

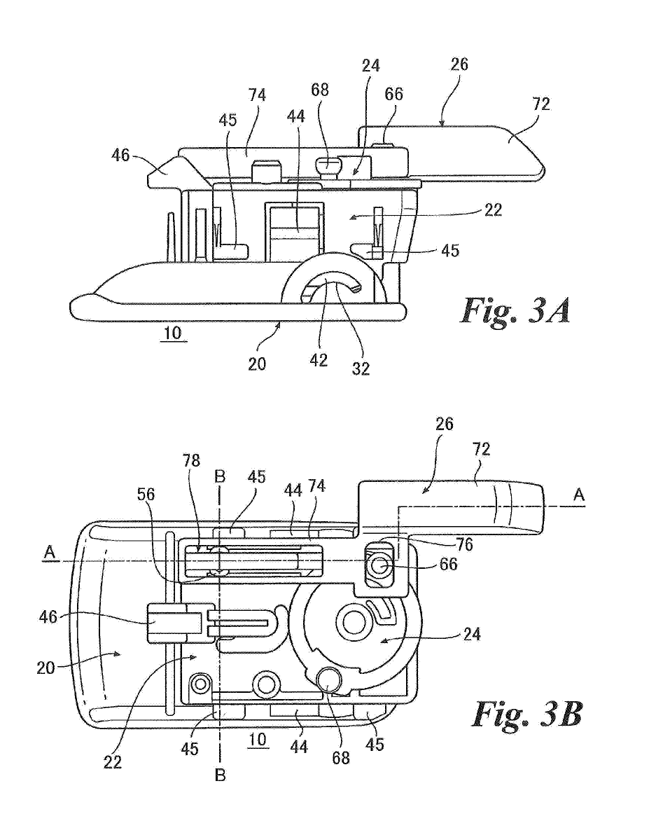

FIG. 2 is a perspective view of the locking device 10 as viewed from a back side thereof. FIG. 3A is a side view of the locking device 10, and FIG. 3B is a back side view of the locking device 10. The second locking member 28 is not illustrated in FIGS. 2, 3A, and 3B. In the present description, same or equivalent constituent elements shown in the drawings are provided with same reference numerals, and repeated descriptions of the same or equivalent constituent elements are omitted as appropriate.

The base member 22 is fixed to the mounting port 12a of the opening and closing member 12 with an engagement structure including engagement pawl portions 44, engaging portions 45, and a mounting hook portion 46. Rotational shaft holes 32 of the manipulation member 20 are inserted with rotational movement supporting portions 42 of the base member 22, and the manipulation member 20 is rotatably supported by the base member 22. Thus, a user can rotationally move the manipulation member 20.

The driving member 24 is housed in the base member 22 such that a first rotor connecting portion 66 and a second rotor connecting portion 68 protrude, and supported about an axis so as to be rotatably moved. The first rotor connecting portion 66 of the driving member 24 is connected to a lock connecting portion 76 of the first locking member 26. The second rotor connecting portion 68 is connected to the second locking member 28. This connection can transmit the rotational movement of the driving member 24 to the locking members.

As illustrated in FIG. 3B, the first locking member 26 includes a first extending portion 72 that extends from the lock connecting portion 76, and a second extending portion 74 that extends from the lock connecting portion 76. The first extending portion 72 is outwardly exposed to be inserted into the engaging hole portion of the glove compartment. The first extending portion 72 and the second extending portion 74 extend in the same longitudinal direction.

The second extending portion 74 functions as a base that is retained by the base member 22 in order to prevent the first locking member 26 from being disconnected from the driving member 24. The second extending portion 74 includes a slide concave portion 78 as a structure that is limited by a limiting portion 56 of the base member 22. The slide concave portion 78 is slidably fitted to the limiting portion 56 of the base member 22.

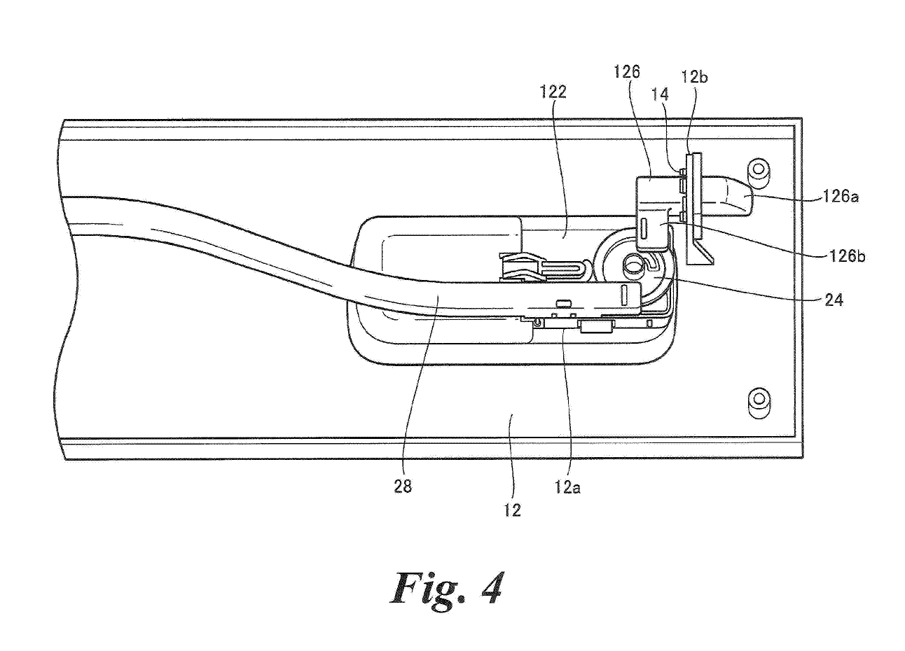

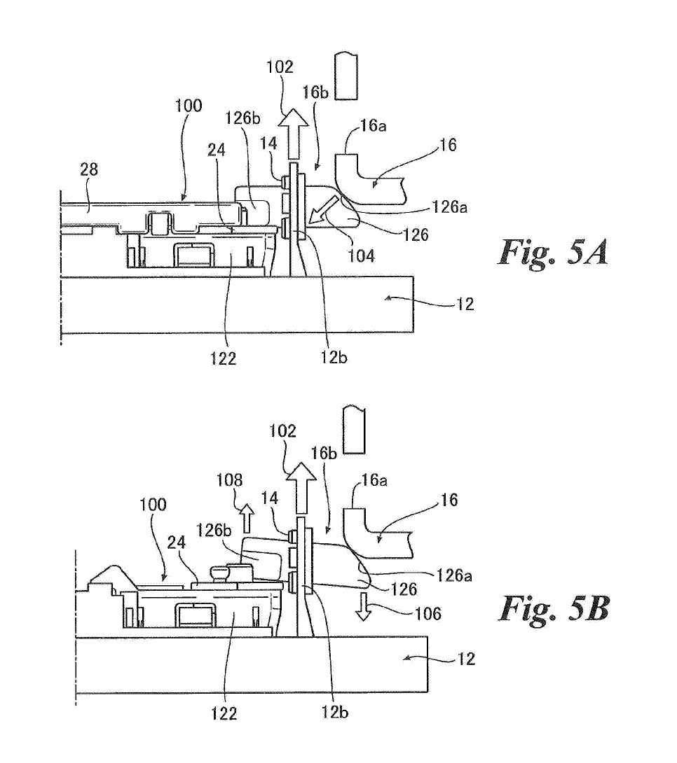

FIG. 4 is a view for illustrating a locking device 100 according to a comparative technique. FIGS. 5A and 5B are views for illustrating the movement of the locking device according to the comparative technique. FIGS. 5A and 5B illustrate movement at the time when a first locking member 126 of the locking device 100 is engaged with an engaging hole portion 16a of a glove compartment 16. In FIG. 5B, the second locking member 28 is not illustrated so that the movement of the first locking member 126 can be seen.

As illustrated in FIG. 4, the locking device 100 according to the comparative technique is different in terms of the shapes of a base member 122 and the first locking member 126 from the locking device 10 according to the present embodiment. However, the locking device 100 according to the comparative technique is same in terms of the other components, and also in terms of a position mounted on the opening and closing member 12 as the locking device 10 according to the present embodiment. The first locking member 126 includes a tapered surface 126a at the distal end, and a connecting portion 126b connected to the driving member 24 at the back portion. However, the first locking member 126 does not extend toward the back side more than the connecting portion 126b. That is, the first locking member 126 does not include the second extending portion 74 of the first locking member 26 of the present embodiment. While the first locking member 126 does not include the second extending portion 74 of the present embodiment, the connecting portion 126b is fitted to be connected to the driving member 24.

A description of the basic movement of the first locking member 126 in closing the opening and closing member 12 will be provided. As illustrated in FIG. 5A, the opening and closing member 12 is moved from the opened state in a closing direction 102 with respect to an opening portion 16b of the glove compartment 16. When abutting on the edge of the opening portion 16b of the glove compartment 16, the first locking member 126 receives a reaction force 104 from the edge of the opening portion 16b.

The first locking member 126 retreats once by the reaction force 104 received from the glove compartment 16 in closing the opening and closing member 12, moves along the edge of a first insertion hole portion 12b while retreating, and when reaching the engaging hole portion 16a, advances by a drive force of the driving member 24. Thus, the distal end portion of the first locking member 126 gets in the engaging hole portion 16a to be brought into a locked state. As described above, when the opening and closing member 12 is moved in the closing direction from the opened state, the distal end portion of the first locking member 126 abuts on the edge of the opening portion 16b to retreat, reaches the engaging hole portion 16a to advance from the retreated position, and is inserted into the engaging hole portion 16a. The driving member 24 includes a coil spring to urge the locking members in a direction of bringing the locking members into the locked state.

The tapered surface 126a of the first locking member 126 abuts on the edge of the opening portion 16b. Thereby, the reaction force 104 that the first locking member 126 receives from the edge of the opening portion 16b includes not only a component in the retreating direction of the first locking member 126 but also a component in the opposite direction that defines the closing direction 102.

As illustrated in FIG. 5B, the first locking member 126 receives torque in the rotation direction with the first insertion hole portion 12b and the retaining portion 14 as a fulcrum by a component 106 in the opposite direction to the closing direction 102. Thus, the back portion of the first locking member 126 might move in a floating-up direction 108. The floating-up direction 108 defines a direction in which the connecting portion 126b of the first locking member 126 is disconnected from the driving member 24.

As illustrated in FIG. 5B, since the mounting position of the locking device 100 mounted on the opening and closing member 12 is shifted, the distance from the first insertion hole portion 12b to the connecting portion 126b is small, and a load based on the reaction force 104 applied to the connecting portion 126b is increased. Thus, a force in the direction 108 in which the connecting portion 126b is disconnected from the driving member 24 is increased. Thus, in the worst case, the connecting portion 126b might be disconnected from the driving member 24.

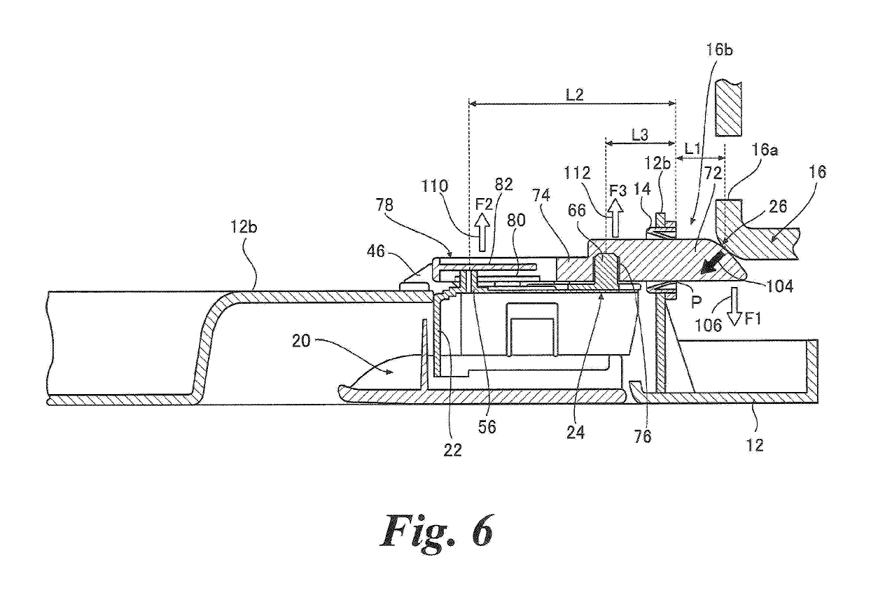

FIG. 6 is a view for illustrating the locking device 10 according to the present embodiment. FIG. 6 is a cross-sectional view of the locking device 10 taken along the line A-A of FIG. 3B, where the locking device 10 is mounted on the opening and closing member 12. The locking device 10 according to the present embodiment has a configuration that the slide concave portion 78 of the first locking member 26 is slidably fitted to the limiting portion 56 of the base member 22.

The limiting portion 56 limits the movement of the lock connecting portion 76, which is disposed on the back side more than the first extending portion 72, in the direction of being disconnected from the driving member 24 when the opening and closing member 12 is moved in the closing direction from the opened state and the first extending portion 72 abuts on the edge of the opening portion 16b. To be specific, the reaction force 104 that the first locking member 26 received from the edge of the opening portion 16b contains a force F1 that is the component 106 in the opposite direction to the closing direction of the opening and closing member 12. Thereby, the first locking member 26 receives torque F2 in the rotation direction with the first insertion hole portion 12b and the retaining portion 14 as a fulcrum P, and thus a force in the floating-up direction 108 acts on the back portion of the first locking member 26.

A distance L1 from the fulcrum P to the position where the first extending portion 72 abuts on the edge of the opening portion 16b, a distance L2 from the fulcrum P to the position where the slide concave portion 78 is fitted to the limiting portion 56, and a distance L3 from the fulcrum P to the lock connecting portion 76 are illustrated in FIG. 6. The balance of moment around the fulcrum P is represented by following Expression (1), and based on Expression (1), Expression (2) is developed.

F1L1=F2L2 Expression 1

F2=F1L1/L2 Expression 2

The torque F2 that is applied on the fitting between the slide concave portion 78 and the limiting portion 56 and expressed by Expression (2) becomes smaller as the distance L2 becomes larger as is shown in the ratio (L1/L2). The smaller the torque F2 becomes, the more hardly the fitting is released. If the fitting is made only with the lock connecting portion 76, torque F3 becomes larger because the distance L3 is smaller than the distance L2.

As described above, the further the fitting between the slide concave portion 78 and the limiting portion 56 is located from the first insertion hole portion 12b, the smaller the load based on the reaction force 104 applied to the fitting becomes. The slide concave portion 78 is in the distance L2 that is longer than the distance L3 from the first insertion hole portion 12b to the lock connecting portion 76, which allows the fitting with the limiting portion 56 to be hardly released. Thus, the limiting portion 56 limits the movement of the second extending portion 74 in the direction in which the lock connecting portion 76 is disconnected from the driving member 24, which allows the lock connecting portion 76 to be hardly disconnected from the driving member 24. Detailed descriptions of the components of the locking device 10 according to the present embodiment will be further provided with reference to the drawings.

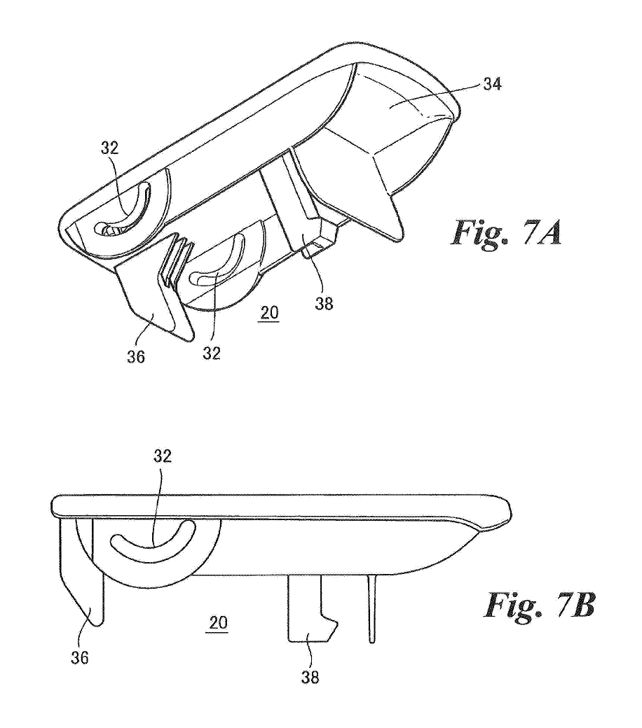

FIGS. 7A and 7B are views for illustrating the manipulation member 20. FIG. 7A is a perspective view of the manipulation member 20 as viewed from a back side thereof, and FIG. 7B is a side view of the manipulation member 20. The front side of the manipulation member 20 is illustrated in FIG. 1A, and is exposed at the mounting port 12a of the opening and closing member 12.

The manipulation member 20 has a plate shape, and includes the rotational shaft holes 32, a manipulation surface 34, a transmission portion 36, and a stopper 38. The rotational shaft holes 32 are each disposed on the pair of side surfaces of the manipulation member 20. The manipulation surface 34 is disposed in the lower portion of the manipulation member 20 on the back surface, and a user can hook his/her fingers on the manipulation surface 34 during the manipulation.

The transmission portion 36 is erected on the back surface of the manipulation member 20 to abut on the driving member 24 to transmit the rotational manipulation by the user to the driving member 24. By connecting the rotational shaft holes 32 to the rotational movement supporting portions 42 of the base member 22, the manipulation member 20 is rotatably supported by the base member 22. When the manipulation member 20 rotationally moves, the transmission portion 36 also rotates to rotationally move the driving member 24. The stopper 38 is erected on the back surface of the manipulation member 20 and abuts on the base member 22 during the manipulation to stop excessive rotation of the manipulation member 20.

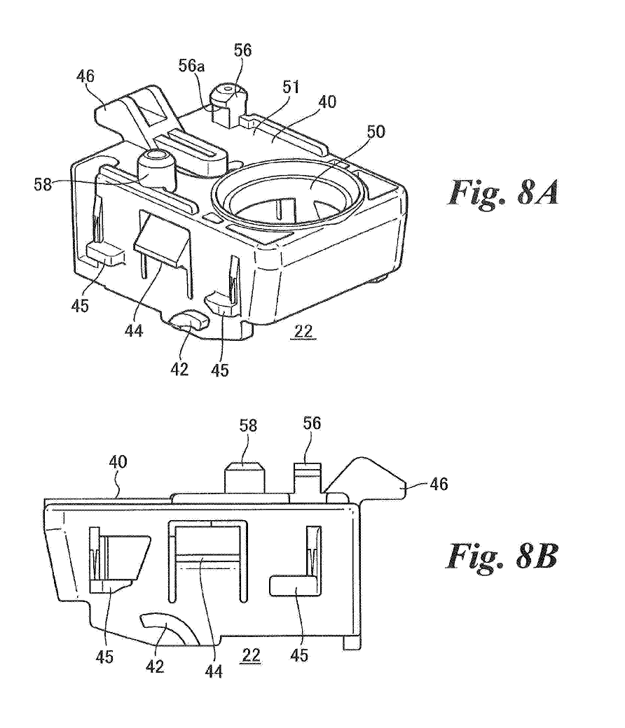

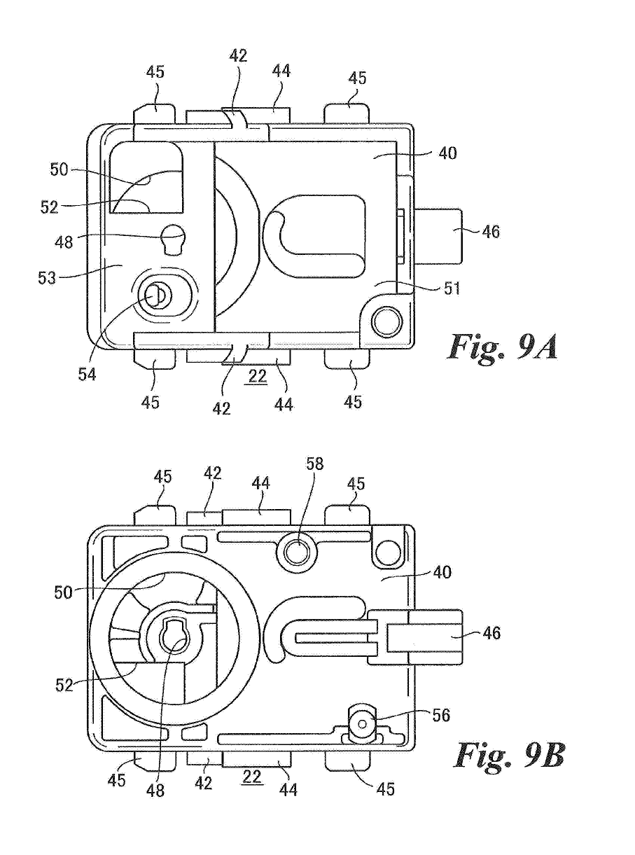

FIGS. 8A, 8B, 9A and 9B are views for illustrating the base member 22. FIG. 8A is a perspective view of the base member 22 as viewed from a back side thereof, and FIG. 8B is a side view of the base member 22. FIG. 9A is a front side view of the base member 22, and FIG. 9B is a back side view of the base member 22.

The main body portion 40 of the base member 22 has a box shape, and includes the engagement pawl portions 44 and the engaging portions 45 on its both sides that are engaged with the edge of the mounting port 12a of the opening and closing member 12. The engagement pawl portions 44 and the engaging portions 45 sandwich the edge of the mounting port 12a therebetween. The mounting hook portion 46 on a back surface 51 of the base member 22 is also hooked and engaged with the edge of the mounting port 12a.

As illustrated in FIGS. 8A and 8B, the rotational movement supporting portions 42 protrude in the width direction from both the sides of the main body portion 40. The rotational movement supporting portions 42 are inserted into the rotational shaft holes 32 of the manipulation member 20 to rotatably support the manipulation member 20. As illustrated in FIG. 9A, a driving bearing portion 48 is provided on a front surface 53 to rotatably support the driving member 24.

As illustrated in FIG. 8A, a rotor supporting wall 50 is made by cutting out the back surface 51 into an annular shape having the driving bearing portion 48 for housing the driving member 24 thereinside. A communicating portion 52 is provided inside the rotor supporting wall 50 by cutting out the front surface 53. The communicating portion 52 defines a through-hole that makes the transmission portion 36 of the manipulation member 20 abut on the driving member 24.

As illustrated in FIG. 8A, a columnar portion 58 is erected so as to protrude from the back surface 51, and has a tapered distal end. The columnar portion 58 is engaged with the second locking member 28, and guides the slide. The limiting portion 56 is erected so as to protrude from the back surface 51, and includes a flange portion 56a on the distal end side that extends outward in the radial direction. The flange portion 56a of the limiting portion 56 is fitted to the second extending portion 74 of the first locking member 26, and guides the slide. The fitting of the limiting portion 56 to the second extending portion 74 limits the movement of the second extending portion 74 in a direction away from the back surface 51.

The limiting portion 56 is fitted to the second extending portion 74, and limits the movement of the first locking member 26 in a direction away from the back surface 51. On the other hand, the columnar portion 58 does not includes a flange portion on the distal end side, and does not limit the movement of the second locking member 28 in a direction away from the back surface 51.

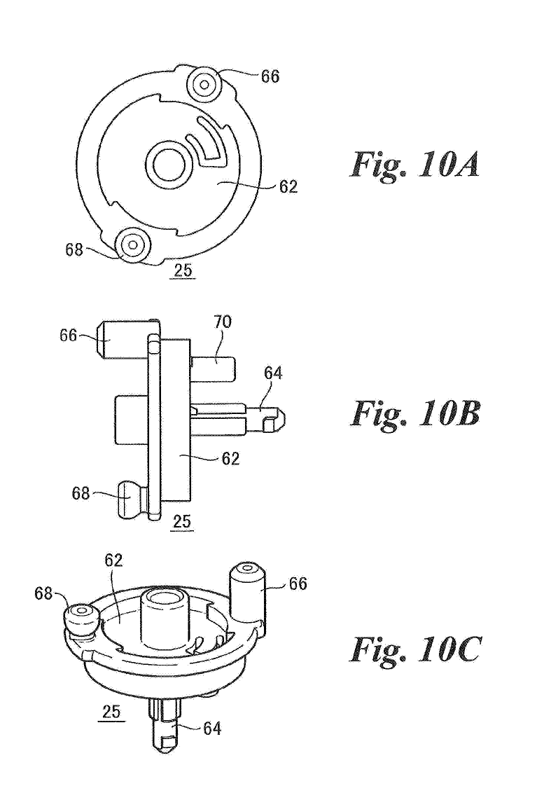

FIGS. 10A to 10C are views for illustrating a rotor member 25 included in the driving member 24. FIG. 10A is a front side view of the rotor member 25, FIG. 10B is a side view of the rotor member 25, and FIG. 10C is a perspective view of the rotor member 25 as viewed from a back side thereof.

The driving member 24 includes the rotor member 25 and a coil spring (not illustrated). The rotor member 25 includes a disk portion 62, a rotating shaft portion 64, the first rotor connecting portion 66, the second rotor connecting portion 68, and a spring bearing portion 70.

The rotating shaft portion 64 is erected vertically in the center of the disk portion 62. The rotating shaft portion 64 is inserted into the driving bearing portion 48 of the base member 22 to be supported about the driving bearing portion 48. The spring bearing portion 70 is erected on the disk portion 62. The coil spring is inserted into the rotating shaft portion 64, and a winding end portion of the coil spring abuts on the spring bearing portion 70. The coil spring urges the rotor member 25 such that the locking members are brought into a locked state. When a user performs unlocking manipulation, the coil spring urges the rotor member 25 in a direction to bring the locking members, which are brought into an unlocked state, into a locked state.

The first rotor connecting portion 66 and the second rotor connecting portion 68 are connected respectively to the first locking member 26 and the second locking member 28, and transmit the rotation movement of the rotor member 25 thereto. The first rotor connecting portion 66 and the second rotor connecting portion 68 protrude vertically on the back surface of the disk portion 62. The first rotor connecting portion 66 and the second rotor connecting portion 68 are distanced from the center of the disk portion 62 on the back surface, and disposed on the outer side in the radial direction on the disk portion 62 so as to face each other.

While both protruding from the disk portion 62, the first rotor connecting portion 66 and the second rotor connecting portion 68 are different in shape. The first rotor connecting portion 66 has a columnar shape with its distal end tapered, and the second rotor connecting portion 68 has its distal end shaped into a flange larger in diameter. The second rotor connecting portion 68 is connected to the second locking member 28 with fitting thereto. On the other hand, the first rotor connecting portion 66 is connected to the first locking member 26 by being inserted thereinto without fitting. Thus, the first rotor connecting portion 66 is easily connected to the lock connecting portion 76.

The second locking member 28 is fitted to the second rotor connecting portion 68 having its distal end shaped into a flange. As illustrated in FIG. 1B, since the distance between the second rotor connecting portion 68 and the second insertion hole portion 12c is very long, the load applied to the fitting portion is small, whereby the fitting is hardly released.

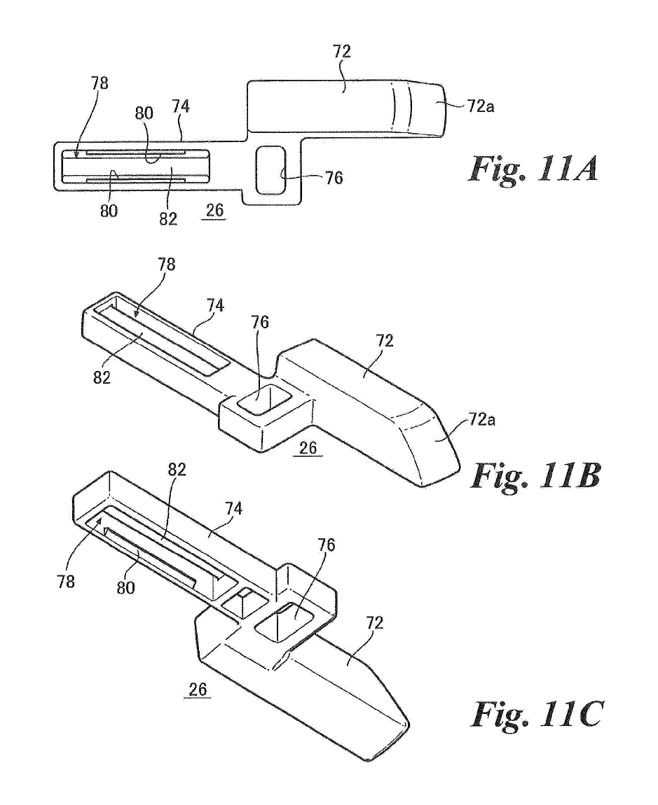

FIGS. 11A to 11C are views for illustrating the first locking member 26. FIG. 11A is a front side view of the first locking member 26, FIG. 11B is a perspective view of the first locking member 26 as viewed from a front side thereof, and FIG. 11C is a perspective view of the first locking member 26 as viewed from a back side thereof.

The first locking member 26 includes the lock connecting portion 76 to be connected to the driving member 24, the first extending portion 72 disposed on the distal end side of the lock connecting portion 76, and the second extending portion 74 disposed on the back side of the lock connecting portion 76. The lock connecting portion 76 is disposed between the first extending portion 72 and the second extending portion 74. The extending directions of the first extending portion 72 and the second extending portion 74 may be parallel to each other.

The first extending portion 72 advances to and retreats from the engaging hole portion 16a of the glove compartment 16 in accordance with the driving of the driving member 24. A tapered surface 72a provided to the distal end portion of the first extending portion 72 is arranged to abut on the edge of the opening portion 16b of the glove compartment 16 to receive a force in a direction of making the first locking member 26 retreat. The first extending portion 72 extends from the lock connecting portion 76 toward a direction in which the first locking member 26 advances while the second extending portion 74 extends from the lock connecting portion 76 toward a direction in which the first locking member 26 retreats. Although the advancing and retreating direction of the first locking member 26 is almost same as the longitudinal direction of the first locking member 26, the advancing and retreating direction of the first locking member 26 is slightly deviated from the longitudinal direction of the first locking member 26 by the rotational orbit of the driving member 24. By making the second extending portion 74 extend from the lock connecting portion 76 toward the direction in which the first locking member 26 retreats and limiting the second extending portion 74 by the limiting portion 56, the structure to prevent the floating-up movement of the sliding second extending portion 74 can be simplified.

The lock connecting portion 76 has a hole shape and is disposed approximately in the center of the first locking member 26, and the first rotor connecting portion 66 of the driving member 24 is inserted into the lock connecting portion 76. The second extending portion 74 includes the slide concave portion 78 to be fitted to the limiting portion 56 of the base member 22.

The slide concave portion 78 is made by cutting out the second extending portion 74 over the longitudinal direction, defines rectangular space inside thereof, has a rectangular and cylindrical shape, and has elasticity. The slide concave portion 78 includes inward protruding portions 80 and an elastic contact portion 82 that are provided inside the slide concave portion 78.

The pair of inward protruding portions 80 protrude on both the inner surfaces of the slide concave portion 78, and face each other to extend like rails in the longitudinal direction. The pair of inward protruding portions 80 is caught by the flange portion 56a of the limiting portion 56, and prevents the second extending portion 74 from getting away from the back surface 51 of the base member 22.

To fit the inward protruding portions 80 of the slide concave portion 78 to the flange portion 56a of the limiting portion 56 when the first locking member 26 is mounted, pushing work is required. On the other hand, as the lock connecting portion 76 is not fitted to the first rotor connecting portion 66, pushing work is not required to connect the lock connecting portion 76 to the first rotor connecting portion 66. After the lock connecting portion 76 is placed above the first rotor connecting portion 66, the first rotor connecting portion 66 is allowed to be easily inserted into the lock connecting portion 76.

The elastic contact portion 82 has a flat plate shape, and extends in the longitudinal direction inside the slide concave portion 78. Both the ends of the elastic contact portion 82 are connected to the inner surface of the slide concave portion 78, and the elastic contact portion 82 has elasticity. The elastic contact portion 82 is flexible in a direction in which the lock connecting portion 76 is disconnected from the first rotor connecting portion 66. The elastic contact portion 82 is brought into elastic contact with the distal end of the limiting portion 56 of the base member 22, to thereby prevent the first locking member 26 from rattling with respect to the limiting portion 56.

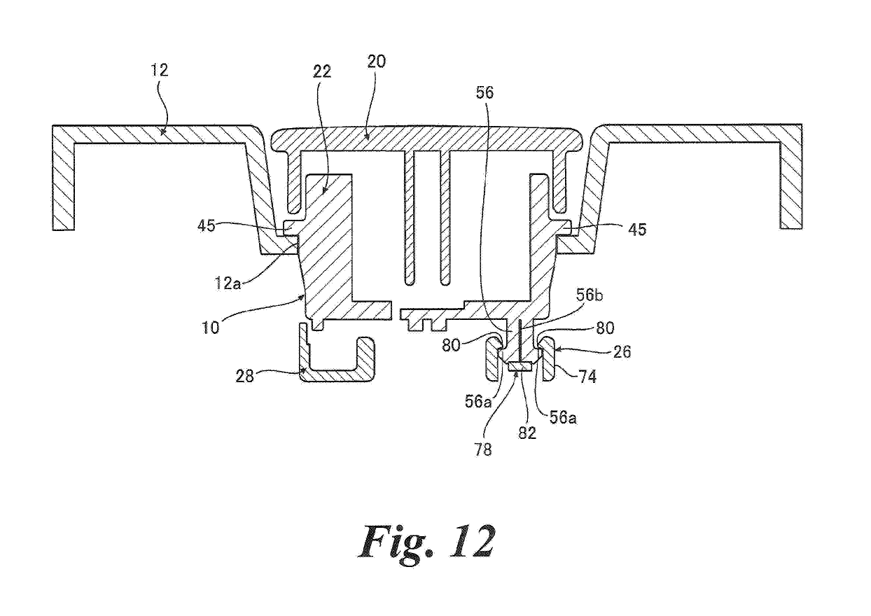

FIG. 12 is a cross-sectional view of the locking device 10 taken along the line B-B of FIG. 3B. The locking device 10 illustrated in FIG. 12 is mounted on the mounting port 12a of the opening and closing member 12. The limiting portion 56 of the base member 22 is fitted to the slide concave portion 78 of the first locking member 26. With this configuration, the first locking member 26 is made hardly moved in a direction away from the base member 22 and the driving member 24, which allows the first locking member 26 to be hardly disconnected from the driving member 24.

To be specific, the inward protruding portions 80 of the slide concave portion 78 are caught by the flange portion 56a of the limiting portion 56, whereby the movement of the first locking member 26 in a direction away from the base member 22 is limited. The slide concave portion 78 defines a fitting concave portion while the limiting portion 56 defines a fitting convex portion to be fitted to the fitting concave portion. With this configuration, the limiting portion 56 is easily fitted to the slide concave portion 78 by pressing the slide concave portion 78 against the limiting portion 56, whereby mounting of the first locking member 26 can be facilitated. The second extending portion 74 disposed on the back side more than the lock connecting portion 76 is limited by the limiting portion 56, whereby mounting of the first locking member 26 on the first insertion hole portion 12b, and mounting of the lock connecting portion 76 can be facilitated.

In the first locking member 26, both the inner surfaces of the slide concave portion 78 abut on the limiting portion 56, whereby the movement of both the inner surfaces of the slide concave portion 78 in the facing direction is limited. The facing direction of both the inner surfaces of the slide concave portion 78 is orthogonal to the advancing and retreating direction of the first locking member 26, and defines the width direction of the locking device 10. Further, the elastic contact portion 82 is brought into elastic contact with the distal end of the limiting portion 56, whereby the first locking member 26 can be prevented from rattling during sliding.

The limiting portion 56 includes a slit 56b that is cut out from the distal end in the protruding direction. The slit 56b makes the limiting portion 56 flexible in the width direction of the locking device 10, which can absorb the movement of the first locking member 26 in the width direction by the rotational orbit of the first rotor connecting portion 66.

When the driving member 24 illustrated in FIG. 3B is rotated, the first locking member 26 moves not only in the longitudinal direction but also in the width direction in accordance with the rotational orbit of the first rotor connecting portion 66. While abutting on the lock connecting portion 76 in the longitudinal direction, the first rotor connecting portion 66 is loosely fitted to the lock connecting portion 76 in the width direction while having gap. With this configuration, the movement of the first rotor connecting portion 66 in the width direction can be absorbed.

As illustrated in FIG. 5B, when the opening and closing member 12 is moved in the closing direction, the second extending portion 74 receives the rotation torque with the edge of the first insertion hole portion 12b as a fulcrum since the first extending portion 72 abuts on the edge of the opening portion 16b of the first extending portion 72. The rotation of the second extending portion 74 is limited by the limiting portion 56. The length of the second extending portion 74 in the longitudinal direction from the lock connecting portion 76 is larger than the length of the first extending portion 72 in the longitudinal direction from the lock connecting portion 76. With this configuration, the fitting position of the slide concave portion 78 to the limiting portion 56 can be disposed away from the first insertion hole portion 12b, and thus the load applied to the fitting portion by the rotation torque with the first insertion hole portion 12b as a fulcrum can be reduced, which allows the first locking member 26 to be hardly disconnected from the driving member 24.

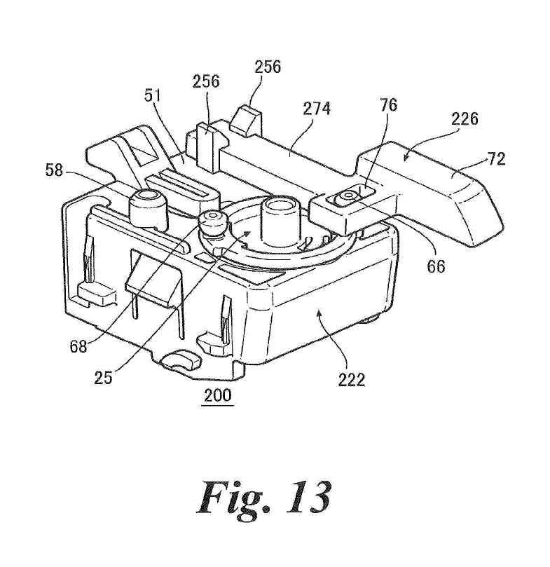

FIG. 13 is a view for illustrating a locking device 200 according to the first modification. FIG. 13 is a perspective view of the locking device 200 as viewed from a back side thereof, where the manipulation member 20 and the second locking member 28 are not illustrated.

The locking device 200 according to the first modification is different from the locking device 10 according to the embodiment illustrated in FIG. 2 in terms of the structure of a fitting portion between a first locking member 226 and a base member 222. A second extending portion 274 according to the first modification that is disposed on the back side more than the lock connecting portion 76 has a rectangular rod shape in cross section that extends in the longitudinal direction from the lock connecting portion 76.

A pair of limiting portions 256 are erected from the back surface 51 of the base member 222. The pair of limiting portions 256 define elastic pawls that face each other in the direction orthogonal to the advancing and retreating direction of the first locking member 226, and are flexible in the facing direction.

By pushing the first locking member 226 from the above, the pair of limiting portions 256 are opened, and receive to be engaged with the second extending portion 274 of the first locking member 226. The second extending portion 274 of the first locking member 226 is slidably fitted to the limiting portions 256 of the base member 222. The limiting portions 256 limit the movement of the first locking member 226 in a direction in which the first locking member 226 is disconnected from the driving member 24, to thereby prevent the floating-up movement of the first locking member 226. As described above, in the locking device 200 according to the first modification, the limiting portions 256 allow the first locking member 226 to be hardly disconnected from the driving member 24.

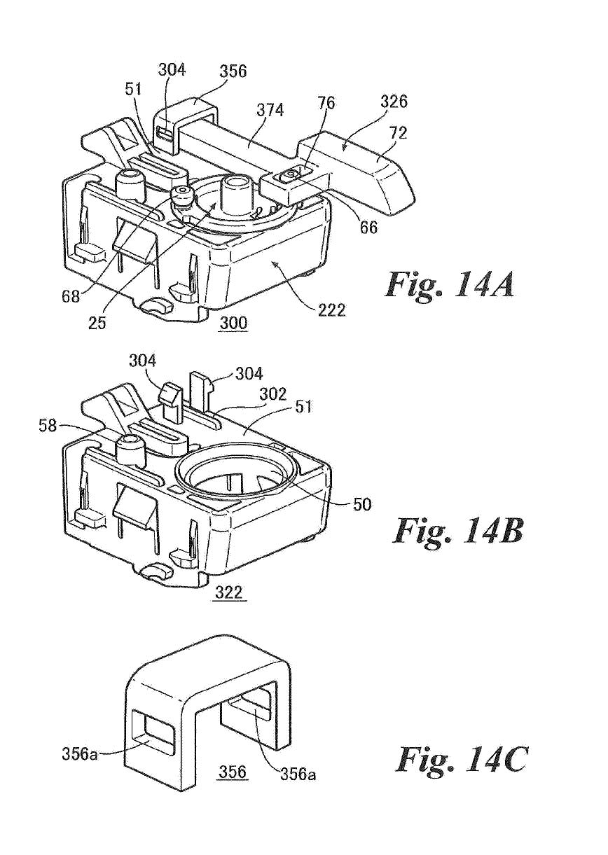

FIGS. 14A to 14C are views for illustrating a locking device 300 according to the second modification. FIG. 14A is a perspective view of the locking device 300 as viewed from a back side thereof, FIG. 14B is a perspective view of a base member 322 as viewed from a back side thereof, and FIG. 14C is a perspective view of a limiting portion 356. The manipulation member 20 and the second locking member 28 are not illustrated in FIG. 14A.

The locking device 300 according to the second modification is different from the locking device 10 according to the embodiment in terms of the structure of a fitting portion between a first locking member 326 and a base member 322. A second extending portion 374 according to the second modification that is disposed on the back side more than the lock connecting portion 76 has a rectangular rod shape in cross section that extends in the longitudinal direction from the lock connecting portion 76.

As illustrated in FIG. 14C, in the locking device 300 according to the second modification, the limiting portion 356 that limits the movement of a first locking member 336 in a direction in which the first locking member 326 is disconnected from the driving member 24 is separate from the base member 322. The limiting portion 356 has an approximately U shape, and includes hole portions 356a on the facing lateral faces

As illustrated in FIG. 14B, the base member 22 includes an advancing and retreating guide portion 302 and a pair of engaging portions 304 on the back surface 51. The advancing and retreating guide portion 302 extends in the advancing and retreating direction of the first locking member 326, and guides the movement of the first locking member 326. A groove portion (not illustrated) that extends in the longitudinal direction and is engaged with the advancing and retreating guide portion 302 is provided on the back surface of the second extending portion 374 of the first locking member 326.

The pair of engaging portions 304 define elastic pawls that are erected on the back surface 51, and face each other in the direction orthogonal to the advancing and retreating direction of the first locking member 326. When mounting the first locking member 326, the second extending portion 374 is disposed between the engaging portions 304, and the limiting portion 356 is pressed from the distal end side of the engaging portions 304. The engaging portions 304 are engaged with the hole portions 356a of the limiting portion 356, and thus the limiting portion 356 is fixed to the base member 322. Thus, the limiting portions 356 limit the movement of the first locking member 326 in a direction in which the first locking member 326 is disconnected from the driving member 24, to thereby prevent the floating-up movement of the first locking member 326. As described above, in the locking device 300 according to the second modification, the separate limiting portion 356 allows the first locking member 326 to be hardly disconnected from the driving member 24.

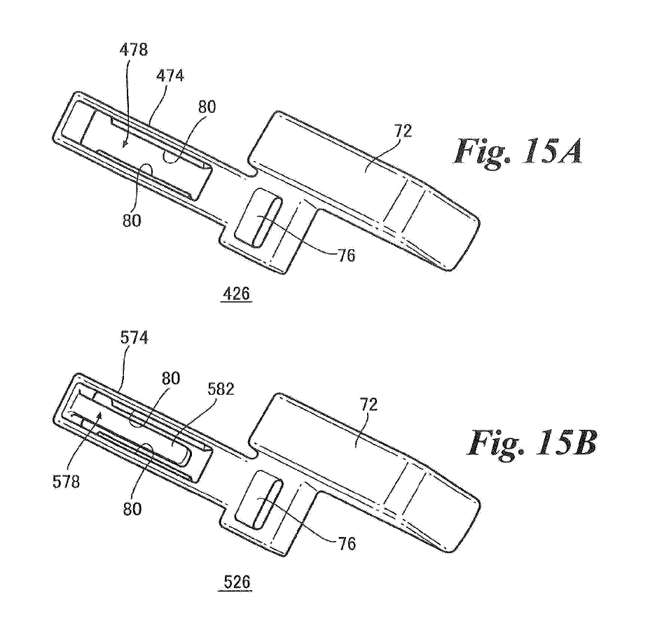

FIG. 15A is a perspective view of a first locking member 426 according to the third modification as viewed from a front side thereof, and FIG. 15B is a perspective view of a first locking member 526 according to the fourth modification as viewed from a front side thereof. The second extending portions of the first locking members according to the third modification and the fourth modification are slidably fitted to the limiting portion 56 of the base member 22.

The first locking member 426 according to the third modification illustrated in FIG. 15A is different from the first locking member 26 according to the embodiment illustrated in FIG. 11A in terms of not including the plate-shaped elastic contact portion 82 inside a slide concave portion 478 of a second extending portion 474. The inward protruding portions 80 are provided inside the slide concave portion 478 according to the third modification, and the slide concave portion 478 can be slidably fitted to the limiting portion 56.

The first locking member 526 according to the fourth modification illustrated in FIG. 15B is different from the first locking member 26 according to the embodiment illustrated in FIG. 11A in that both the ends of an elastic contact portion 582 provided inside a slide concave portion 578 of a second extending portion 574 are not connected to the slide concave portion 578, but only one end of the elastic contact portion 582 is connected to the inner surface of the slide concave portion 578. The elastic contact portion 582 defines a cantilever piece that extends in the longitudinal direction from the back end of the slide concave portion 578.

The elastic contact portion 582 changes the force of urging the limiting portion 56 in accordance with the advancing and retreating movement of the first locking member 526. The elastic contact portion 582 increases the resistance against the advance rate of the first locking member 526 as getting closer to the position where the first locking member 526 is brought into a locked state from an unlocked state. Thereby, hammering generated when the locking device is completely brought into a locked state is reduced.

A limiting portion 556 that abuts on the elastic contact portion 582 changes the position in the longitudinal direction where the limiting portion 556 abuts on the elastic contact portion 582 in accordance with the advancing and retreating movement of the first locking member 526. The elastic contact portion 582 acts on the limiting portion 56 such that an urging force at the distal end of the elastic contact portion 582 is smaller while an urging force at the back end is larger.

The more the first locking member 526 retreats, the smaller the urging force of the elastic contact portion 582 acting on the limiting portion 56 becomes, and the smaller the friction resistance during sliding becomes. The elastic contact portion 582 urges the limiting portion 56 relatively strongly, and the friction resistance becomes large in a state where the first locking member 526 advances most while the elastic contact portion 582 urges the limiting portion 56 relatively weakly, and the friction resistance becomes small in a state where the first locking member 526 retreats most. The friction resistance between the elastic contact portion 582 and the limiting portion 56 in a state where the first locking member 526 is in a locked state is larger than the friction resistance in a state where the first locking member 526 is in an unlocked state.

With this configuration, the friction resistance against the first locking member 526 becomes larger when the first locking member 526 is being brought into an locked state from an unlocked state. Thereby, the movement of the first locking member 526 in the advancing direction can ben be gradually decreased in speed. Thus, hammering generated when the locking device is completely brought into a locked state can be reduced.

The present invention is not limited to the embodiments described above, and it is also possible to add modifications such as various kinds of design changes to the embodiments based on the knowledge of those skilled in the art. Embodiments to which such modifications are added can also be included within the scope of the present invention.

In the embodiment, as illustrated in FIG. 6, the first locking member 26 rotates with the first insertion hole portion 12b and the retaining portion 14 as a fulcrum. However, the present invention is not limited thereto. For example, when the opening and closing member 12 is closed and the first extending portion 72 abuts on the edge of the opening portion 16b, the first locking member 26 may abut on the edge close to the engaging hole portion 16a on the back surface of the base member 22 by the force F1, and the first locking member 26 may rotate with the edge on the back surface of the base member 22 as a fulcrum.

In the embodiment, the second extending portion 74 extends from the lock connecting portion 76. However, the present invention is not limited thereto. The second extending portion 74 may extend directly from the first extending portion 72 toward the back side in the longitudinal direction.

In the embodiment, the protrusion-shaped limiting portion 56 is disposed on the back surface 51 of the base member 2. However, the present invention is not limited thereto. For example, a limiting portion may be disposed so as to protrude on the back surface of the depressed portion 12d of the opening and closing member 12. The limiting portion of the opening and closing member 12 is slidably fitted to the slide concave portion 78 of the first locking member 26.

In the embodiment, the first rotor connecting portion 66 of the rotor member 25 has a columnar shape with its distal end tapered. However, the present invention is not limited thereto. For example, the first rotor connecting portion 66 may have its distal end larger in diameter like the second rotor connecting portion 68 illustrated in FIG. 10C, and may be fitted to the lock connecting portion 76 of the first locking member 26. With this configuration, the first locking member 26 is allowed to be more hardly disconnected from the driving member 24.

In the embodiment, the slide concave portion 78 that defines a fitting concave portion is provided to the first locking member 26, and the limiting portion 56 that defines a fitting convex portion is provided to the base member 22. However, the present invention is not limited thereto. For example, the second extending portion 74 of the first locking member 26 may include a fitting convex portion while the base member 22 may include a fitting concave portion. The fitting convex portion of the first locking member 26 is slidably fitted to the fitting concave portion of the base member 22 in the longitudinal direction of the first locking member 26.

In the fourth modification, as illustrated in FIG. 15B, the elastic contact portion 582 defines a cantilever piece that can change the urging force acting on the limiting portion 56. However, the present invention is not limited thereto. For example, while both the ends of an elastic contact portion are connected to the slide concave portion 78, changing the thickness of the elastic contact portion in the longitudinal direction can change the urging force on the limiting portion 56 by the elastic contact portion during sliding. The elastic contact portion acts on the limiting portion 56 such that an urging force at the distal end of the elastic contact portion is smaller while an urging force at the back end is larger, so that the elastic contact portion is made such that the distal end is small in thickness while the back end side is large in thickness.

### DESCRIPTION OF REFERENCE NUMERALS AND SIGNS

10 Locking device
12 Opening and closing member
12a Mounting port
12b First insertion hole portion
12c Second insertion hole portion
12d Depressed portion
14 Retaining portion
16 Glove compartment
16a Engaging hole portion
16b Opening portion
20 Manipulation member
22 Base member
24 Driving member
25 Rotor member
26 First locking member
28 Second locking member
32 Rotational shaft hole
34 Manipulation surface
36 Transmission portion
38 Stopper
40 Main body portion
42 Rotational movement supporting portion
44 Engagement pawl portion
45 Engaging portion
46 Mounting hook portion
48 Driving bearing portion
50 Rotor supporting wall
52 Communicating portion
54 Spring supporting portion
56 Limiting portion
56a Flange portion
58 Columnar portion
62 Disk portion
64 Rotating shaft portion
66 First rotor connecting portion
68 Second rotor connecting portion
70 Spring bearing portion
72 First extending portion
72a Tapered surface
74 Second extending portion
76 Lock connecting portion
78 Slide concave portion
80 Inward protruding portion
82 Elastic contact portion

### INDUSTRIAL APPLICABILITY

The present invention relates to a locking device to be mounted on an opening and closing member.

1. (canceled)

2. (canceled)

3. (canceled)

4. (canceled)

5. (canceled)

6. (canceled)

7. A locking device that is mounted on an opening and closing member provided in an openable and closable manner to an opening portion of a mount-base member so as to hold the opening and closing member in a locked stated, the locking device including:
a driving member that drives in accordance with manipulation of a manipulation member;
a locking member that includes:
a connecting portion connected to the driving member;
a first extending portion that extends from the connecting portion and advances to and retreats from an engaging hole portion formed in the mount-base member in accordance with driving of the driving member; and
a second extending portion that extends from one of the connecting portion and the first extending portion;
a limiting portion that limits movement of the second extending portion in a direction of disconnecting the connecting portion from the driving member; and
a base member that rotatably supports the driving member,
wherein the limiting portion is formed on the base member so as to limit movement of the locking member in a direction away from the base member.

8. A locking device that is mounted on an opening and closing member provided in an openable and closable manner to an opening portion of a mount-base member so as to hold the opening and closing member in a locked stated, the locking device including:
a driving member that drives in accordance with manipulation of a manipulation member, and that includes a driving-member-side connecting portion having a protruding shape;
a locking member that includes:
a locking-member-side connecting portion connected to the driving-member-side connecting portion by being inserted thereto;
a first extending portion that extends from the locking-member-side-connecting portion and advances to and retreats from an engaging hole portion formed in the mount-base member in accordance with driving of the driving member; and
a second extending portion that extends from one of the locking-member-side connecting portion and the first extending portion; and
a limiting portion that has a protruding shape, and that limits movement of the second extending portion in a direction of disconnecting the locking-member-side connecting portion from the driving-member-side connecting portion,
wherein the second extending portion is limited in a state of being pushed into the limiting portion along the protruding shape thereof, and
wherein a direction in which the driving-member-side connecting portion has been pushed into the locking-member-side connecting portion corresponds to a direction in which the second extending portion has been pushed into the limiting portion.

9. The locking device of claim 7,
wherein the second extending portion extends toward a direction in which the locking member retreats.

10. The locking device of claim 7,
wherein the first extending portion retreats by abutting on the mount-base member when the opening and closing member is moved in a closing direction, and advances to reach the engaging hole portion from a retreated position, and
wherein the limiting portion prevents a floating-up movement of the second extending portion by abutting the first extending portion on the mount-base member in moving the opening and closing member in the closing direction.

11. The locking device of claim 7,
wherein the first extending portion is outwardly exposed through an insertion hole provided to the opening and closing member, and is disposed movable in and out of the engaging hole portion, and
wherein the limiting portion limits rotation of the second extending portion with an edge of the insertion hole as a fulcrum, the rotation being made by abutting the first extending portion on the mount-base member in moving the opening and closing member in the closing direction.

12. The locking device of claim 7,
wherein either one of the second extending portion and the limiting portion includes a fitting convex portion, and an other one of the second extending portion and the limiting portion includes a fitting concave portion to be slidably fitted to the fitting convex portion.

13. The locking device of claim 12,
wherein the fitting concave portion includes an elastic contact portion that is brought into elastic contact with the fitting convex portion.

14. The locking device of claim 8, further including:
a base member that rotatably supports the driving member,
wherein the limiting portion is formed on the base member so as to limit movement of the locking member in a direction away from the base member.

15. The locking device of claim 14,
wherein the limiting portion is slidably fitted to the second extending portion, and
wherein the driving-member-side connecting portion is connected to the locking-member-side connecting portion without fitting thereto.

16. The locking device of claim 7,
wherein the locking device is disposed on the opening and closing member at a position shifted to one side from a center in a width direction, and
wherein the locking device further includes:
another locking member that is connected to the driving member, and that is longer in a longitudinal direction than the locking member.
